(19) United States
(12) Patent Application Publication
(10) Pub. No.: US 2013/0260804 A1
(43) Pub. Date: Oct. 3, 2013

(54) APPARATUS AND METHOD FOR WIRELESS NETWORK CONNECTION

(71) Applicants: Ki-Ryong Ha, Daejeon (KR); Jeun-Woo Lee, Daejeon (KR)

(72) Inventors: Ki-Ryong Ha, Daejeon (KR); Jeun-Woo Lee, Daejeon (KR)

(73) Assignee: Electronics and Telecommunications Research Institute, Daejeon (KR)

(21) Appl. No.: 13/997,048

(22) PCT Filed: Dec. 22, 2011
(86) PCT No.: PCT/KR11/10008

§ 371 Date: Jun. 21, 2013

(30) Foreign Application Priority Data
Dec. 22, 2010 (KR) 10-2010-0132879

(51) Int. Cl. H04W 76/02

(52) U.S. Cl. CPC H04W 76/021
USPC 455/500

(57) ABSTRACT

Disclosed is a wireless network connection technique which minimizes a standby time required for connection to a wireless sharer or the like to thereby improve the convenience of using a wireless network. To this end, the apparatus for wireless network connection according to the present invention comprises: a wireless sharer information management unit which searches for a unique connection identifier of a wireless sharer; virtualization unit which generates a virtual network adapter obtained by virtualizing a network adapter to a software; and a network connection control unit which, when the unique connection identifier is retrieved by the wireless sharer in information management unit, enables the virtualization unit to generate the virtual network adapter and enables the virtual network adapter to determine whether the unique connection identifier is available.

### TECHNICAL FIELD

The present invention relates to an apparatus and method for wireless network connection. More particularly, the present invention relates to an apparatus for wireless network connection to minimize a standby time required for connecting to a wireless sharer and to improve convenience of using a wireless network.

The present invention claims the benefit from Korean Patent Application No 10-2010-0132879, filed on Dec. 22, 2010, in the Korean Intellectual Property Office, the entire disclosure of which is incorporated herein by reference.

### BACKGROUND ART

Many elements of individual computing tasks are being performed through a network and thus, a concept of cloud computing is becoming widespread. In particular, with the advent of various computing devices, for example, smart phones, users desiring to perform computing work without time and location restrictions are also increasing. Under such circumstances, a demand for a wireless network is dramatically increasing. A mobile network for providing a wireless network environment may be characteristically divided into a third generation (3G) data network provided by a mobile communication company, and a wireless fidelity (WiFi) network, also referred to as a wireless local area network (WAN). WiFi networks have a higher speed than 3G data networks, and hold an advantage in that, in many cases, WiFi networks may be used for free. Thus, a WiFi network may be preferred by numerous smart phone users. However, in the case of the WiFi network, a connection to a new wireless sharer requires frequent updates because a wireless coverage area is rather limited. This condition of performing frequent connection updates may hinder use of a wireless Internet environment by a user. Particularly, not only a mobile communication company but also, an individual may install a large number of wireless sharers having an appearance of a smart phone. Due to a plethora of access points corresponding to the large number of wireless sharers, the user needs to spend as large amount of time in finding a wireless sharer that may actually be available. In addition, many wireless sharers allow the user to use the wireless sharer without entering a password, and use a method such as a media access control (MAC) address authentication to allow a predetermined user to access the wireless sharer. Accordingly, as general user who accesses the wireless sharer spends a great deal of time determining an availability of a corresponding sharer. Thus, there is a need for a method that enables a user to quickly locate a wireless sharer that is actually available.

### DISCLOSURE OF INVENTION

### Technical Goals

An aspect or the present invention is to enable a user using a mobile terminal to to access a wireless sharer conveniently and quickly through virtualization of network hardware, that is, a network adapter. Particularly an aspect of the present invention is to improve convenience of using a wireless network in a mobile environment.

Another aspect of the present invention is also to promptly identify an available service set identifier (SSID) from among SSIDs of various types of wireless sharers provided to an environment in which a user is located. Concisely, an aspect of the present invention is to minimize a standby time required for connection to the wireless sharer, when the user desires to use the wireless Internet through a wireless fidelity (WiFi) network.

Another aspect of the present invention is also to increase a rate of connection to a wireless network by simultaneously determining availability using a number of virtual network adapters corresponding to a number of found SSIDs.

### Technical Solutions

According to an aspect of the present invention, there is provided an apparatus for wireless network connection, the apparatus including a wireless sharer information management unit to search for a service set identifier (SSID) of a wireless sharer, a virtualization unit to generate a virtual network adapter by virtualizing a network adapter using software, and a network connection control unit to enable the virtualization unit to generate the virtual network adapter and to control the virtual network adapter to determine availability of the SSID, when the SSID is found by the wireless sharer information management unit.

In this instance, the network sharer information management unit may include SSID search unit to search fur the SSID of the wireless sharer, and an SSID list storage unit to store a list of the SSID found by the SSID search unit.

In this instance, the network connection control unit may control a list of SSIDs that are determined to be available for the virtual network adapter to be stored in the SSID list storage unit.

In this instance, the network connection control unit may control the virtual network adapter to determine whether an unidentified SSID, aside from the available SSID, among the SSID found by the wireless sharer information management unit.

In this instance, the network connection control unit may control the virtual network adapter to determine availability of the SSID by requesting connection to a predetermined Internet domain.

In this instance, the network control unit may control the virtualization unit to generate at least one virtual network adapter corresponding to a number of SSIDs found by the wireless sharer information management unit, and controls each of the virtual network adapters to simultaneously determine availability of each corresponding SSID respectively.

According to another aspect of the present invention, there is also provided a method for wireless network connection, the method including, searching, for an SSID of as wireless sharer, generating a virtual network adapter by virtualizing a network adapter using software, and determining, by the virtual network adapter, availability of found SSIDs.

In this instance, the method may further including defining SSIDs that are determined to be available for the virtual network adapter, and storing a list of the available SSID.

In this instance, the determining may be performed with respect to an unidentified SSID, aside from the available SSID among the SSIDs found in the searching for the SSID.

In this instance, the determining may determine availability of the SSID by requesting connection to a predetermined Internet domain by the virtual network adapter.

In this instance, the generating may generate at least one virtual network adapter corresponding to a number of the SSIDs found in the searching for the SSID.

In this instance, the determining may simultaneously determine availability of each corresponding SSID by each of the virtual network adapters respectively.

### Effects of the Invention

According to embodiments of the present invention, a user using a mobile terminal may access a wireless sharer conveniently and quickly through virtualization of network hardware, that is, a network adapter. In particular, it is possible to improve convenience of using a wireless network in a mobile environment.

According to embodiments or the present invention, an available service, set identifier (SSID) may be promptly identified from among SSIDs of various types of in wireless sharers provided to an environment in which a user is located. Concisely, it is possible to improve convenience of a user by minimizing a standby time required for connection to the wireless sharer, when the user desires to use the wireless Internet through a wireless fidelity (WiFi) network.

According to embodiments of the present invention, a rate of connection to a wireless network may be increased by simultaneously determining availability using a number of virtual network adapters corresponding to a number of found SSIDs.

### BRIEF DESCRIPTION OF DRAWINGS

FIG. 1 is a block diagram illustrating a configuration of an apparatus for wireless network connection according to an embodiment of the present invention.

FIG. 2 is a flowchart illustrating a method for wireless network connection according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. Here, a repeated description and a description relating to a known function and configuration that may render the present invention ambiguous will be omitted. The embodiments are provided in order to further fully explain the present invention to a person having ordinary skill in the art. Accordingly, shapes and sizes of constituent elements and the like in the drawings may be exaggerated for further clear description.

Hereinafter, a configuration and an operation of an apparatus for wireless network connection according to an embodiment of the present invention will be described.

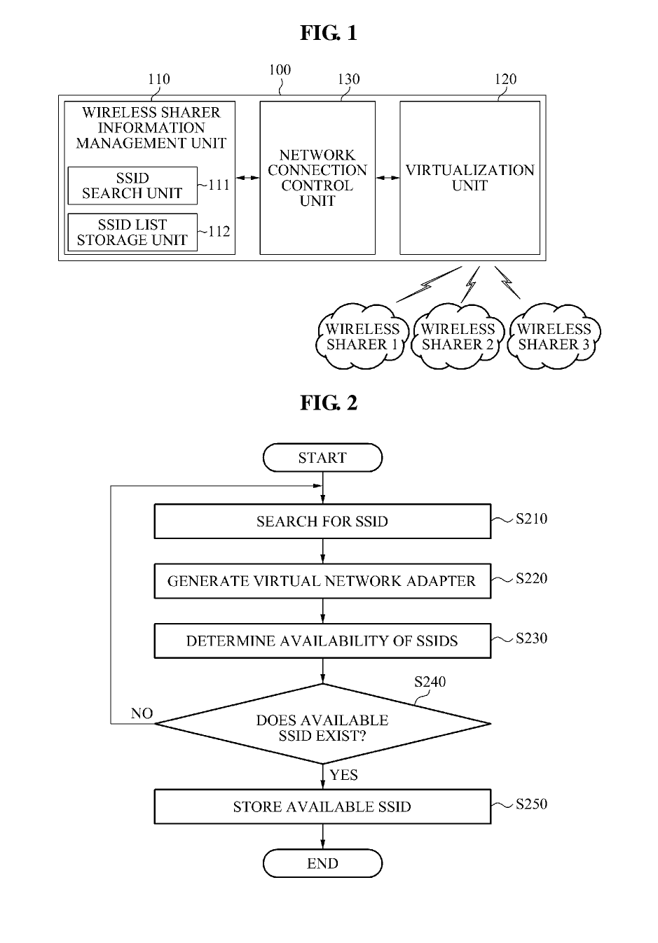

FIG. 1 is a block diagram illustrating a configuration of an apparatus for wireless network connection according to an embodiment of the present invention.

Referring to FIG. 1, an apparatus for wireless net connection 100 according to an embodiment of the present invention includes a wireless sharer information management unit 110, a virtualization unit 120, and a network connection control unit 130.

The wireless sharer information management unit 110 searches for a service set identifier (SSID) of a wireless sharer. The wireless sharer information management unit 110 includes an SSID search unit 111. Also, the wireless sharer information management unit 110 may further include an SSID list storage unit 112, For exam pie in FIG. 1, the wireless sharer information management unit 110 searches for an SSID of each of the wireless sharers 1, 2, and 3.

The SSID search unit 111 searches for the SSID of the wireless sharer. For example, the SSID search unit 111 searches for a plurality of SSIDs that may be found in a predetermined point.

The SSID list storage unit 112 stores a list of SSIDs found by the SSID search unit 111, In this instance, the SSID list storage unit 112 may store a list of available SSIDs that are determined to be available for a virtual network adapter.

The virtualization unit 120 generates the virtual network adapter by virtualizing a function and an interface of the network adapter using software. The virtualization unit 120 may generate a number of virtual network adapters corresponding to a number of the SSIDs found by the SSID search unit 111 according to a control of the network connection control unit 130 to be described later. In this instance, each of the virtual network adapters may simultaneously determine availability of each corresponding SSID. For example in FIG. 1, since three SSIDs were found with respect to the wireless sharers 1, 2, and 3, the virtualization unit 120 may generate three virtual network adapters. Further, the three virtual network adapters simultaneously determine availability for the SSIDs of the wireless Share 1, 2, and 3, respectively. In this instance in SSID being available indicates that connection to an Internet network is possible using a wireless sharer connected through the corresponding SSID. A meaning of the SSID being available differs from a meaning that connection to the wireless sharer is possible, because a case exists in which connection to the wireless sharer is possible but actual use of the wireless sharer is impossible. For example, when a wireless sharer determines availability using a media access control (MAC) address, a user terminal may make a connection using an SSID provided by a corresponding wireless sharer, however, may not actually use the Internet.

The network connection control unit 130 controls the virtualization unit 120 to generate the virtual network adapter, when the SSID is found by the wireless sharer information management unit 110. Further, the network connection control unit 130 controls the virtual network adapter to determine availability of the SSID. In this instance, a method, such as a transmission control protocol (TCP) connection Internet control message protocol (ICMP) response, may be used for determining availability.

Further, the network connection control unit 130 controls a list of available SSIDs that are determined to be available for the virtual network adapter found among the SSIDs to be stored in the SSID list storage unit 112.

Further, the network connection control unit 130 may control the virtual network adapter to determine availability only with respect to an unidentified SSID, aside from the available SSID stored in the SSID search unit 111. More particularly, repetitive access to an available SSID once determined to be available may be disallowed.

Further, the network connection control unit 130 may control the virtual network adapter to determine availability of the SSID by requesting connection to a predetermined Internet domain.

Further, the network connection control unit 130 may control the virtualization unit 120 to generate a number of virtual network adapters corresponding to a number of SSIDs found by the wireless sharer information management unit 110. The network connection control unit 130 may control each of the virtual network adapters to determine availability of each corresponding SSID, respectively. Accordingly, compared to a case in which a single piece of hardware determines availability with respect to each of a plurality of SSIDs at a time, the present invention enables as plurality of virtual network adapters to simultaneously determine availability with respect to the plurality of SSIDs, thereby enabling a prompt network connection.

Hereinafter, as method for wireless network connection according to an embodiment of the present invention will be described.

FIG. 2 is a flowchart illustrating a method for wireless network connection according to an embodiment of the present invention.

Referring to FIG. 2. initially, in the method for wireless network connection according to an embodiment of the present invention, an SSID of a wireless sharer in a predetermined point is searched for in operation S210.

In operation S220, a virtual network adapter is generated by virtualizing a function and an interface of a network adapter using software. In this instance, at least one virtual network adapter corresponding to a number of SSIDs found ma be generated in operation S210.

In operation S230, availability of SSIDs found by the virtual network adapter in operation S210 is determined. In this instance, each of virtual network adapters generated in correspondence to at least one of the number of SSIDs may simultaneously determine availability for each corresponding SSID, respectively.

In operation S240, whether an SSID that is determined to be available for the virtual network adapter exists among the SSIDs is determined. In this instance, operation S240 may be performed only with respect to an unidentified SSID, aside from the available SSID previously determined to be available, among the SSIDs found in operation S210. In addition, operation S240 may be performed in such a manner that the virtual network adapter requests connection to a predetermined Internet domain and determines availability with respect to the SSID.

When it is determined that an available SSID does not exist in operation S240, an additional SSID is continuously searched tier by returning to operation S210.

Conversely, when it is determined that an SSID determined to be available exists in operation S240, the SSID determined to be available may be defined to be an available SSID. Further, the available SSID is stored in a predetermined storage unit in operation S250.

As described above, the apparatus and method for wireless network connection according to an embodiment of the present invention are not limited a configuration and a method of the above-mentioned embodiment to be applied. Instead, all or part of each embodiment may be selectively combined and configured in order to be made varied chances of the embodiments.

1. An apparatus for wireless network connection, the apparatus comprising:
a wireless sharer information management unit search for a service set identifier (SSID) of a wireless sharer;
a virtualization unit to generate a virtual network adapter by virtualizing a network adapter using software; and
a network connection control unit to enable the virtualization unit to generate the virtual network adapter and to control the virtual network adapter to determine availability of the SSID, when the SSID is found by the wireless sharer information management unit.

2. The apparatus of claim 1, in the network sharer information management unit comprises:
an SSID search unit to search for the SSID of the wireless sharer; and
an SSID list storage unit to store a list of the SSID found by the SSID search unit.

3. The apparatus claim 2, wherein the network connection control unit controls a list of available SSIDs that are determined to be available for the virtual network adapter to be stored in the SSID list storage unit.

4. The apparatus of claim 3, wherein the network connection control unit controls the virtual network adapter to determine whether an unidentified SSID, aside from the available SSID, among the SSID found by the wireless sharer information management unit.

5. The apparatus of claim 1, wherein the network connection control unit controls the virtual network adapter to determine availability of the SSID by requesting connection to a predetermined Internet domain.

6. The apparatus of claim 1, wherein the network control unit controls the virtualization unit to generate at least one virtual network adapter corresponding to a number of SSIDs found by the wireless sharer information management unit, and controls each of the virtual network adapters to simultaneously determine availability of each corresponding SSID, respectively.

7. A method for wireless network connection, the method comprising:
searching for an SSID of a wireless sharer;
generating a virtual network adapter by virtualizing a network adapter using software; and
determining, by the virtual network adapter, availability of found SSIDs.

8. The method of claim 7, further comprising defining SSIDs that are determined to be available for the virtual network adapter, and storing a list of the available SSID.

9. The method of claim 8, wherein the determining is performed with respect to an unidentified SSID, aside from the available SSID, among the SSIDs found in the searching for the SSID.

10. The method of claim 7, wherein the determining complies determining, by the virtual network adapter, availability of the SSID by requesting connection to a predetermined Internet domain.

11. The method of claim 7, wherein the generating comprises generating at least one virtual network adapter corresponding to a number of the SSID found in the searching for the SSID.

12. The method of claim 11, wherein the determining comprises simultaneously determining, by each of the virtual network adapters, availability of each corresponding SSID respectively.
